(19) United States
(12) Patent Application Publication
(10) Pub. No.: US 2005/0044561 A1
(43) Pub. Date: Feb. 24, 2005

(54) Methods and apparatus for identifying program segments by detecting duplicate signal patterns

(75) Inventor: Russel McDonald, Pflugerville, TX (US)

Correspondence Address: CHARLES G. CALL, 68 HORSE POND ROAD, WEST YARMOUTH, MA, 02673-2516, US

(73) Assignee: Gotuit Audio, Inc., Andover, MA (US)

(21) Appl. No.: 10/644,350

(22) Filed: Aug. 20, 2003

(51) Int. Cl. H04N 7/16; G06K 9/00; H04N 7/10; H04N 7/025; H04H 9/00

(52) U.S. Cl. 725/18; 725/32; 725/19; 382/181

(57) ABSTRACT

A broadcast program receiving and recording device which identifies songs and commercials within the recorded content by searching the content for repeating segments, and bookmarking segments that substantially duplicate other segments as being either songs (if longer than about two minutes) or commercials (if shorter than about two minutes). Repeating duplicate segments are identified by using a Haar wavelet transform to identification values that are placed in a searchable database for comparison with identification values representative of other content. Bookmarking records are used to identify repeating segments.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Reference to Computer Program Listing Appendix

A computer program listing appendix is stored on each of two duplicate compact disks which accompany this specification. Each disk contains computer program listings which illustrate implementations of the invention. The listings are recorded as ASCII text in IBM PC/MS DOS compatible files which have the names, sizes (in bytes) and creation dates listed below:

| File Name | Created | Bytes |
|---|---|---|
| SoundAccess.dsp | May 16, 2002 | 5,544 |
| SoundAccess.dsw | May 15, 2002 | 547 |
| SoundAccess.h | May 15, 2002 | 34,096 |
| SoundAccess.IDL | May 15, 2002 | 4,238 |
| SoundAccess.plg | May 16, 2002 | 266 |
| SoundAccess.RC | May 15, 2002 | 2,878 |
| SoundAccess.tlh | May 15, 2002 | 6,655 |
| SoundAccess.tli | May 15, 2002 | 7,516 |
| SoundAccess_i.c | May 15, 2002 | 1,170 |
| SoundAccess_p.c | May 15, 2002 | 80,103 |
| SoundBuffer.cpp | May 16, 2002 | 109,038 |
| SoundBuffer.h | May 16, 2002 | 8,744 |
| SourceSelection.CPP | May 16, 2002 | 3,763 |
| SourceSelection.H | May 16, 2002 | 2,978 |
| StatusDiskSpace.cpp | May 16, 2002 | 3,310 |
| STDAFX.CPP | Mar. 29, 2001 | 315 |
| Stdafx.h | Aug. 16, 2001 | 1,016 |
| testauto.cpp | Feb. 25, 2002 | 1,709 |
| testauto.h | Feb. 25, 2002 | 1,464 |
| ThresholdsDlg.cpp | May 16, 2002 | 4,064 |
| ThresholdsDlg.h | May 16, 2002 | 2,326 |
| TIPS.cpp | May 16, 2002 | 4,780 |
| TIPS.h | May 16, 2002 | 2,005 |
| VolumeHigh.cpp | May 16, 2002 | 8,442 |
| VolumeHigh.h | May 16, 2002 | 2,742 |
| VSSVER.SCC | Aug. 16, 2001 | 288 |
| AboutBox.cpp | Mar. 23, 2002 | 1,159 |
| AboutBox.h | Mar. 08, 2002 | 1,205 |
| AdminDlg.cpp | May 16, 2002 | 9,039 |
| AdminDlg.h | May 16, 2002 | 2,708 |
| DLGPROXY.CPP | Mar. 29, 2001 | 3,264 |
| DLGPROXY.H | Mar. 29, 2001 | 1,782 |
| Dlldata.c | May 15, 2002 | 843 |
| FASHDlg.cpp | May 16, 2002 | 10,890 |
| FASHDlg.h | May 16, 2002 | 3,164 |
| HelpDlg.cpp | Feb. 24, 2002 | 2,312 |
| HelpDlg.h | Feb. 24, 2002 | 1,490 |
| HelpTips.cpp | Apr. 08, 2002 | 5,318 |
| HelpTips.h | Apr. 08, 2002 | 1,293 |
| hlp.cpp | Feb. 24, 2002 | 1,614 |
| hlp.h | Feb. 24, 2002 | 1,404 |
| HTTPSEND.TXT | Jul. 13, 2001 | 442 |
| iVolumeCalibration.cpp | Feb. 26, 2002 | 636 |
| iVolumeCalibration.h | Feb. 26, 2002 | 601 |
| ManualDlg.cpp | May 16, 2002 | 4,538 |
| ManualDlg.h | May 16, 2002 | 2,468 |
| MATCHMaker.CPP | May 15, 2002 | 142,562 |
| MATCHMaker.dsp | Apr. 18, 2002 | 4,644 |
| MATCHMaker.dsw | May 15, 2002 | 545 |
| MATCHMaker.H | May 15, 2002 | 34,101 |
| MATCHMaker.plg | May 16, 2002 | 1,671 |
| Milliseconds.CPP | Jun. 22, 2003 | 2,001 |
| Milliseconds.H | Jun. 22, 2003 | 826 |
| MSSCCPRJ.SCC | May 15, 2002 | 196 |
| MusicRecognitionGUI.CPP | May 16, 2002 | 4,661 |
| MusicRecognitionGUI.dsp | May 16, 2002 | 7,121 |
| MusicRecognitionGUI.dsw | May 15, 2002 | 563 |
| MusicRecognitionGUI.H | May 16, 2002 | 2,901 |
| MusicRecognitionGUI.odl | Mar. 24, 2002 | 4,628 |
| MusicRecognitionGUI.plg | May 16, 2002 | 5,271 |
| MusicRecognitionGUI.rc | Apr. 09, 2002 | 29,187 |
| MusicRecognitionGUI.REG | Mar. 29, 2001 | 771 |
| MusicRecognitionGUIDlg.CPP | May 16, 2002 | 135,255 |
| MusicRecognitionGUIDlg.H | May 16, 2002 | 12,790 |
| PIPLUS.CPP | Mar. 29, 2001 | 4,337 |
| PlayList.cpp | May 16, 2002 | 2,451 |
| PlayList.h | May 16, 2002 | 2,330 |
| README.TXT | Mar. 29, 2001 | 1,275 |
| RecallStarter.CPP | May 22, 2001 | 2,420 |
| RecallStarter.H | May 22, 2001 | 1,553 |
| RecognitionLogDlg.CPP | Jun. 16, 2001 | 1,130 |
| RecognitionLogDlg.H | Jun. 16, 2001 | 1,329 |
| Register.bat | May 15, 2002 | 24 |
| resource.h | May 15, 2002 | 504 |
| SongContext.cpp | May 16, 2002 | 6,254 |
| SongContext.h | May 16, 2002 | 2,483 |
| SongLengthInfo.CPP | May 05, 2002 | 30,958 |
| SongLengthInfo.H | May 05, 2002 | 3,844 |
| SoundAccess.CPP | May 16, 2002 | 4,499 |
| SoundAccess.DEF | May 15, 2002 | 230 |

### FIELD OF THE INVENTION

This invention relates to methods and apparatus for recording and reproducing broadcast programming and more particularly, although in its broader aspects not exclusively, to methods and apparatus for identifying and delimiting individual program segments in a received and recorded broadcast program signal.

### BACKGROUND OF THE INVENTION

A variety of systems have been developed for identifying audio and video program content provided to listeners and viewers on recording media and via broadcast services, including transmission over the airwaves, via satellite and by cable systems. These identification systems have been employed to provide users with descriptive metadata, such as program and song titles, the names of performing artists, etc. In addition, to meet the needs of commercial advertisers and copyright owners who are interested in monitoring systems to determine when various recordings and commercials are broadcast on radio or television, identification systems have identified individual segments of the broadcast content by imbedding ancillary identification signals in the broadcast signal. Other identification systems have compared the broadcast signal with “fingerprint” or “signature” data which can be extracted from the received broadcast signal and compared with a database of fingerprint data which identifies a collection of pre- recorded program content.

An early system for identifying program content is described in U.S. Pat. No. 3,919,479 to Moon et al. issued on Nov. 11, 1975. The Moon et al. system utilizes a non-linear analog transform to produce a low frequency envelope waveform, and the information in the low frequency envelope of a predetermined time interval is digitized to generate a signature. The signatures thus generated are compared with reference signatures to identify the program. The disclosures of this patent and each of the patents and the patent application identified in the remainder of this background section, are hereby incorporated herein by reference.

U.S. Pat. No. 4,450,531 issued to Kenyon et al. on May 22, 1984 describes an automatic radio program recognition system in which the broadcast signal is processed to generate successive digitized broadcast signal segments which are correlated with the digitized, normalized reference signal segments to obtain correlation function peaks for each resultant correlation segment. The spacing between the correlation function peaks for each correlation segment is then compared to determine whether such spacing is substantially equal to the reference signal segment length.

U.S. Pat. No. 4,697,209 issued to Kiewit et al. on Sep. 29, 1987 describes a system for identifying programs such as television programs received from various sources by detecting the occurrence of predetermined events such as scene changes in a video signal and extracts a signature from the video signal. The signatures and the times of occurrence of the signatures are stored and subsequently compared with reference signatures to identify the program.

U.S. Pat. No. 4,739,398 issued to Thomas et al. on Apr. 19, 1988 describes a system for recognizing broadcast segments, such as commercials, in real time by continuous pattern recognition without resorting to cues or codes in the broadcast signal. Each broadcast frame is parametized to yield a digital word and a signature is constructed for segments to be recognized by selecting, in accordance with a set of predefined rules, a number of words from among random locations throughout the segment and storing them along with offset information indicating their relative locations. As a broadcast signal is monitored, it is parametized in the same way and the library of signatures is compared against each digital word and words offset therefrom by the stored offset amounts. A data reduction technique minimizes the number of comparisons required while still maintaining a large database.

U.S. Pat. No. 4,918,730 issued to Klause Schulze on Apr. 17, 1990 describes an arrangement for automatically recognizing signal sequences such as speech or music signals, particularly for the statistical evaluation of the frequency of play of music titles. An envelope signal is generated from each preset signal sequence (e.g., music title) and time segments of the envelope signals are continually compared with the stored segments of the envelope signals of the preset signal sequences. When a preset degree of concordance is exceeded, a recognition signal is generated.

U.S. Pat. No. 6,574,594 issued to Pitman et al. on Jun. 3, 2003 describes a system for monitoring broadcast audio content in which a broadcast datastream is received, audio identifying information is generated representing audio content from the broadcast datastream, and the identifying information is compared with an audio content database.

U.S. Pat. No. 6,147,940 issued to Carl Yankowski on Nov. 14, 2000 describes a system in which a database of information describing songs recorded on compact disks and played using a CD changer is stored on a personal computer descriptive metadata from an external server using information from the volume table of contents (TOC) stored on the CD to identify the song being played and display the associated data. The system uses the TOC data or other “fingerprint” of a CD in order to search the remote database for information such as title, track names, artist, etc. Once the CD is identified, the information associated with the CD can be loaded into a local database so that the user can search for desired music, artists, etc. In addition, the information is loaded into the memory of a CD player so that discs stored in the CD player can be readily identified.

U.S. Pat. No. 6,088,455 issued to James D. Logan et al. on Jun. 11, 2000 describes systems that use a signal analyzer to extract identification signals from broadcast program segments. These identification signals are then sent as metadata to the listener where they are compared with the received broadcast signal to identify desired program segments. For example, a user may specify that she likes Frank Sinatra, in which case she is provided with identification signals extracted from Sinatra's recordings which may be compared with the incoming broadcast programming content to identify the desired Sinatra music, which is then saved for playback when desired.

U.S. Patent Application 200-0120925 filed by James D. Logan and published on Aug. 29, 2002 describes audio and video program recording, editing and playback systems for utilizing metadata created either at a central location for shared use by connected users, or created at each individual user's location, to enhance user's enjoyment of available broadcast programming content. A variety of mechanisms are employed for automatically and manually identifying and designating programming segments, including “fingerprint” or “signature” signal patterns that can be compared with incoming broadcast signals to identify particular segments, and further timing information, which specifies the beginning and ending of each segment relative to the location of the unique signature. The fingerprint and metadata are used to selectively record and play back desired programming.

There is a need for improved methods and apparatus for identifying recorded segments imbedded in media content provided to listeners and viewers.

There is a particular need for improved methods and apparatus for identifying recorded segments, such as songs and commercials, in broadcast program content that is received and locally stored in a memory device at the receiving location

### SUMMARY OF THE INVENTION

The present invention may be employed to identify segments of a broadcast program signal by receiving a broadcast program signal from an available source, recording the signal in a storage device, and identifying repeating segments of said broadcast program signal. Because both commercials and musical recordings (“songs”) are typically pre-recorded and are broadcast repeatedly, the detection of repeating segments in the stored program allows those repeating segments to be distinguished from other programming. Since songs are typically about two minutes long or longer, while commercials are considerably shorter, the duration of the detected repeating segments may be used to distinguish songs from commercials.

In a device for receiving and recording broadcast programming, repeating segments may be identified with “bookmarks” and these bookmarks may be used to allow a radio listener (or a television viewer) to skip, forward or backward, from the beginning of one repeating segment to the next (e.g., from one song to the next in recorded radio broadcast content). Bookmarked repeating segments may be placed on a “playlist” which may be formed by a file of bookmark records, allowing the user to identify individual repeating segments for later playback. User selected segments may also be persistently saved to form a “jukebox” of program segments selected by the user for potential future use.

In accordance with a feature of the preferred embodiment of the invention, repeating segments are detected by comparing portions of the broadcast program signal previously received and recorded at different times, or from different sources, to identify substantially duplicate segments. The comparison is advantageously performed by extracting a sequence of identification data, called a “fingerprints,” from the recorded content and then comparing the fingerprints.

In accordance with a further feature of the invention, the fingerprints are preferably formed by processing the recorded content signal with a wavelet transform, such as the Haar wavelet transform, and generating the fingerprint values from the wavelet coefficients created by the transform. When matching fingerprint values identifying similar content are identified, sequences of substantially matching fingerprints are identified which indicate the location and duration of substantially duplicate segments in the original content.

In accordance with a feature of the preferred embodiment of the invention, the stored fingerprint values indicate the waveshape of the program content signal rather than its amplitude, thereby permitting duplicate repeating program segments to be more easily identified notwithstanding the presence of signal noise, different signal strengths, different equalization techniques used by the broadcaster, and other factors.

In a preferred embodiment, matching fingerprint values are located by extracting key values from a sequence of wavelet coefficients and then storing fingerprint values in a data lookup table indexed by the key values. The use of an indexed lookup table, such as a hash table, speeds the search for substantially duplicate program segments and reduces the computational burden of the processor employed.

In the preferred embodiment, the key values are produced by sorting a sequence of wavelet coefficients, investigating the sort order of sorted coefficients to identify complex or significant waveforms, and using a value indicative of the sort order as the key value by which the data lookup table for storing fingerprint values is stored.

In accordance with a further aspect of the invention, the wavelet-based fingerprints and sort order key values may be employed to link metadata which describes repeating program segments. For example, metadata identifying songs by title, artist, album title, recording company, and other information may be associated with individual segments and displayed to the listener to facilitate playback.

The novel signal comparison mechanism using wavelet-based fingerprints may be applied to advantage in systems for monitoring the broadcast of songs, commercials and other pre-recorded content, systems for monitoring the viewing and listening habits of users to create usage data and statistics, and systems for identifying selected broadcast program segments and obtaining descriptive information about those segments.

These and other objects, features, advantages, and applications of the invention may be more clearly understood by considering the following detailed description of a specific embodiment of the invention. In the course of this description, frequent reference will be made to the attached drawings.

### BRIEF DESCRIPTION OF THE DRAWINGS

FIG. 1 is a block signal flow diagram illustrating the principal functions performed by a radio recording and playback system that embodies the invention; and

FIGS. 2 and 3 show a flowchart which describes the manner in which repeating program segments are identified in the system shown in FIG. 1.

### DETAILED DESCRIPTION

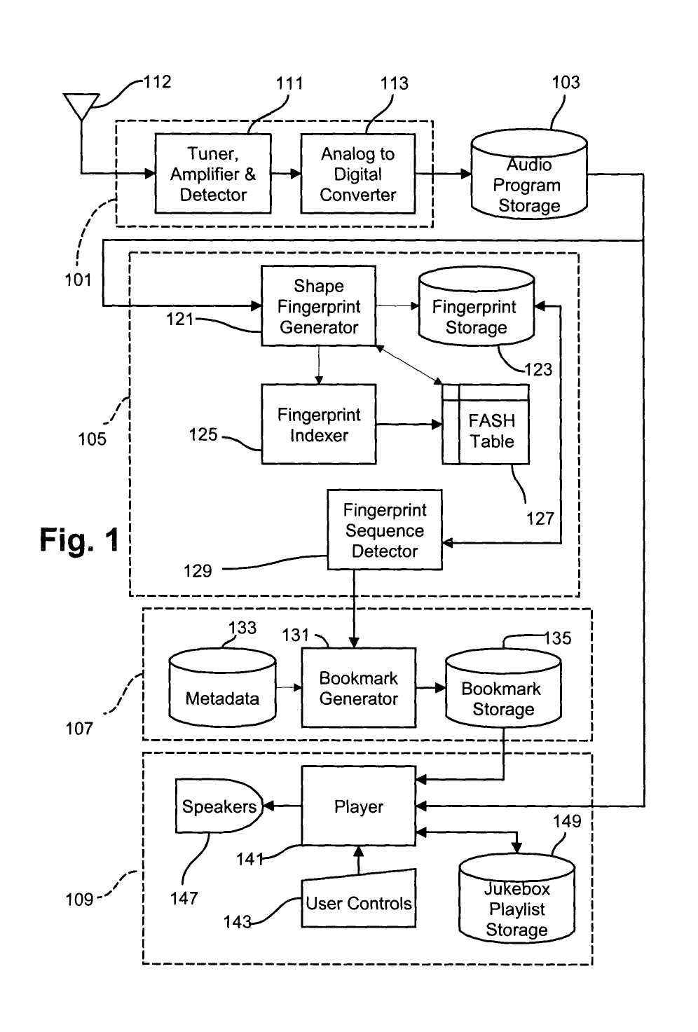

A radio receiver, recorder and playback unit that embodies the invention is shown in FIG. 1. The unit includes a bookmarking mechanism that automatically identifies repeating content and enables a listener to more readily locate and play back desired content in the received and recorded radio programming. For example, the listener can jump from the beginning of one song to the beginning of another song during playback.

The unit consists of a receiver section 101 for receiving broadcast radio programming, a digital audio storage device 103 for storing the received programming; a segment matching unit 105 that identifies repeating segments within the recorded audio content; a bookmarking unit 107 that generates and stores bookmark records that identify and classify detected repeating segments; and a playback unit 109 that employs the bookmark records to enable the listener to select and play back desired program segments.

The receiver section 101 includes a conventional radio tuner, amplifier and detector 111 connected to an antenna 112 for receiving an audio signal from one or more selected broadcast radio stations, and an analog-to-digital converter 113 for producing a sequence of digital values each indicating the amplitude of samples of the captured audio waveform. The digitized samples may be stored in the audio program storage unit 103 as a digital file of standard format, such as the “wav” format commonly used in the Microsoft Windows operating system. The digital audio signal may also be compressed prior to storage, and decompressed upon retrieval from storage, using conventional compression formats, such as MP3 compression.

The segment matching unit 105 identifies repeating, duplicate segments within the audio programming recorded in the storage unit 103. Repeating matching segments having a duration greater than approximately two minutes are typically pre-recorded music (“songs”), whereas shorter matching audio segments are typically pre-recorded commercials.

When the segment matching unit 105 identifies repeating duplicate audio segments, the bookmarking unit 107 generates and stores bookmark records which specify the location the matching segments in the audio program store 103. The bookmark may, for example, consist of a sequence of records indicating the starting and ending address of each matching segment, together with a unique identification number that identifies the particular song, commercial or repeating segment. The duration of each segment may be determined from the starting and ending addresses, and the segment may be initially classified (as a song or as a commercial) based on its duration.

The matching unit 105 employs a mechanism for searching for and identifying substantially matching sequences of fingerprints stored in the fingerprint storage unit 123. Matching segments are identified by first extracting fingerprints which indicate the waveshape of the audio waveform over a brief interval of time, and then searching for substantially matching sequences of fingerprints indicating possibly duplicate, repeating audio segments. A waveshape fingerprint extractor seen at 121 in FIG. 1 converts sequences of digital sample amplitude values from the audio program store 103 into fingerprint values stored in the fingerprint storage unit 123. Each stored fingerprint value is preferably representative of the waveshape of the audio signal over a brief interval of time, and matching sequences of substantially similar fingerprints indicate the presence of the same pre- recorded audio segment broadcast at different times and possibly by different broadcast stations selected by the receiver 101. To speed the search for matching segments, a fingerprint indexer 125 generates index values which are indicative of the shape of the audio waveform over an brief interval. Each unique fingerprint index value is used to address a factorial hash (FASH) table 127 so that newly generated fingerprint values can be more rapidly compared with fingerprint values previously stored in the FASH table. When matching FASH values are found, the extent to which sequences of consecutive fingerprints stored in the fingerprint storage unit 123 match previously stored sequences is determined at 129, yielding an identification of the beginning and ending positions of matching audio segments which is passed to the bookmarking unit 107.

The bookmarking unit 107 consists of a bookmark record generator 131 which receives the identification of repeating, duplicate audio segments from the segment matching unit 105 and generates bookmark records which preferably identify the starting and ending locations of each segment in the audio program store (or alternatively, the starting location and the duration of each matching segment). Each bookmark record may also identify the source (e.g. selected radio station) from which the content was received. The bookmarking record also preferably contains an identification value provided from the fingerprint storage (123) which uniquely specifies the particular repeating segment, such as a song or commercial.

This identification value may be used as a key value for linking the bookmark to metadata from an available source 133. In this way, the bookmarking data stored in a bookmark storage unit 135 may specify not only the location, duration and type (song, commercial, etc.) of the identified segments, but further describe the content of the segment (e.g. song title, performer, album name, publisher, etc.).

The bookmark records in the bookmark storage unit 135 are employed to advantage by the playback unit 109. The playback unit 109 consists of a player 141 that retrieves stored digital audio signals from the audio program storage unit 103 under the supervision of a user controls 143 operated by the listener. The player 141 converts the digital values from the program storage unit into an audio signal (decompressing the digitized signal if has been compressed), and delivers an output audio signal to the speakers 147. If desired, the user may also listen to “live” broadcasts directly from the receiver 101. The player further include a display device 149 for displaying prompting messages, metadata (song titles, etc.) and other information (e.g. current live station identification) to assist the listener in operating the playback unit.

Using the user controls 143, the listener may navigate or “surf” through recorded segments. For example, by pressing a “next song” button, the listener may skip to the beginning of the next song in the audio program storage. Unlike pressing the station select buttons on a conventional car radio, the next song button always plays songs from their beginning, and skips commercials and disk jockey talk.

The playback unit 109 further includes a “jukebox” playlist storage unit 151. When the listener identifies a song or other segment she would like to listen to again, a “save” control in user control unit 143 may be actuated to add the identified segment to a “playlist” in the storage unit 151. A playlist may comprise a file of bookmark records extracted from the bookmark storage unit 135, or simply a file of key values, which identify a collection of segments and the order in which they are to be played. The user may then later play those segments specified on an individual playlist.

As noted earlier, received broadcast signals in audio form are continually saved to the audio program storage unit 103, fingerprints representative of the received program signals are continually stored in the fingerprint storage unit 123, and the FASH table 127 is continually updated to provide an index to fingerprint storage. The metadata in the metadata store may be initially loaded into the unit when delivered to the customer, and may be periodically updated via the Internet or from a suitable source. To this end, the metadata store may conveniently take the form of a removable memory card that may be connected to a personal computer and updated from time to time via the Internet. The same memory card may be used to provide archival storage of bookmarked program segments which are placed on a playlist by the user.

To conserve memory space, the content of the audio program store 103 may be periodically rewritten to eliminate older content that has not been repeated in more recent content and content that has been duplicated (preferably saving the “better” copy determined by some criteria, such as the signal strength of the original received program or the absence of detected noise or interference). Segments which have been placed on a “playlist” may be protected against deletion until the playlist is discarded.

Segment Matching

The segment matching unit 105 and the bookmarking unit 107 may be implemented using a suitably programmed microprocessor coupled to a random access memory and one or more suitable mass storage devices, such as a magnetic disk memory.

The segment matching unit 105 shown in FIG. 1 recognizes those parts of the recorded audio signal that repeat. Signal storage and recognition take place concurrently and continuously. The system can simultaneously monitor a radio station, record the received content, recognize songs and commercials as repeating signals, and bookmark or capture the recognized songs and commercials for later playback.

Segment matching is accomplished by extracting fingerprint values that indicate unique attributes of the audio signal. A search is then conducted for like fingerprints which indicate an earlier broadcast of the same audio content. It is accordingly desirable to extract fingerprint values which represent “significant” features of the audio waveform which can be identified notwithstanding factors such as noise, recording volume, equalization and other processing parameters which can create significant differences between the different received and recorded versions of the same original pre-recorded program segment, such as a music recording. The preferred fingerprinting technique accordingly focuses on the “rough shape” of a received signal over time, while ignoring the size of the signal.

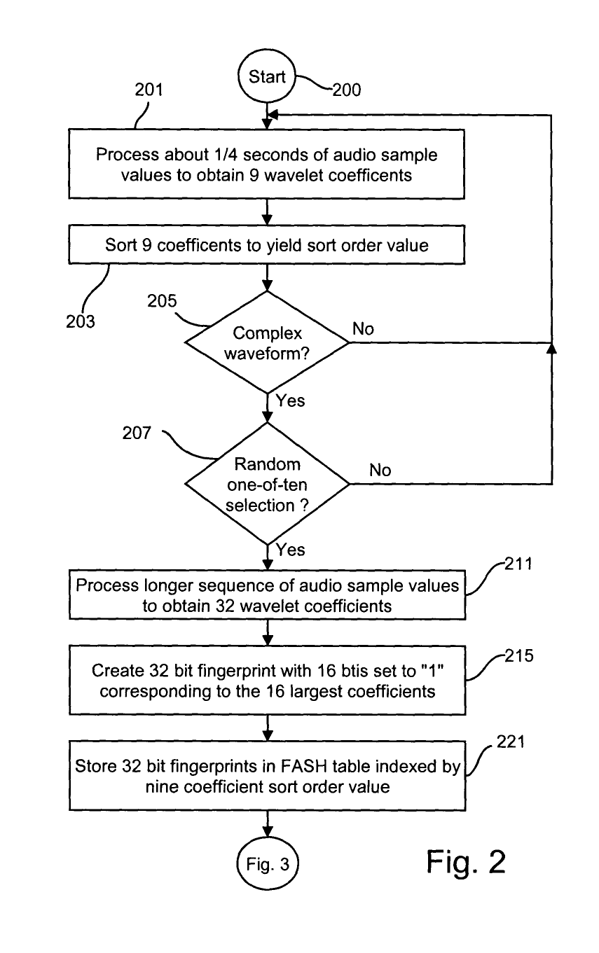

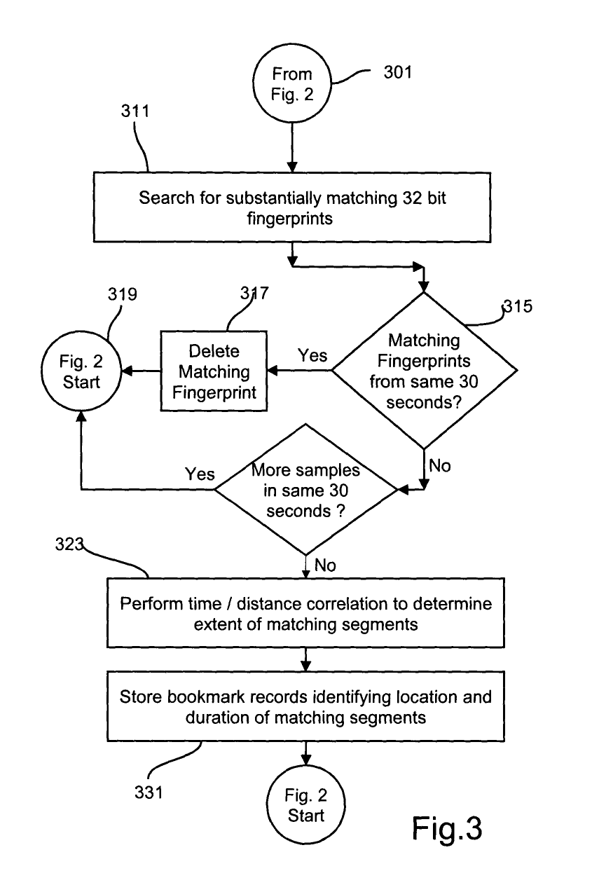

An overview of the preferred implementation of the program segment matching mechanism is presented below in connection with the flowchart seen in FIGS. 2 and 3. The details of the fingerprint generation and searching mechanism are set forth in the accompanying computer program listing. The preferred technique to be described uses a modified Haar wavelet transform to compute wavelet coefficients from the digital sample values representing the original audio waveform. The wavelet coefficients are then processed to create stored fingerprints, and to create unique factorial hash table index values (FASH index values) which allow the fingerprint data to be more rapidly searched for matches.

Wavelet processing in general, and the Haar wavelet transform in particular, are well known and described in the available literature. See, for example, A Primer on Wavelets and Their Scientific Applications by James S. Walker and Steve G. Krantz, CRC Press; (March 1999) ISBN: 0849382769 and Wavelet Methods for Time Series Analysis by Donald B. Percival and Andrew T. Walden, Cambridge University Press (October 2000) ISBN: 0521640687. It should be noted that, although a modified Haar wavelet transform has been employed in specific implementation to be described, other wavelet transforms described in the literature can be used.

As shown in FIG. 1, the received analog program signal captured by the receiver 102 is stored in digitized form in a audio program storage unit 103. The stored digital signal represents a sequence of digital sample amplitude values taken having a sufficient resolution (16 bit amplitude values) at a sampling rate (22.05 kHz) yielding a recording quality consistent with that provided by broadcast radio services. The operation of the segment matching unit seen at 105 in FIG. 1 is described in more detail in connection with the flowchart seen in FIGS. 2 and 3, and in full detail in the accompanying program listing appendix. Segment matching is performed by a programmed processor, such as Intel Pentium processor of the kind commonly used in personal computers. The program listing in the accompanying appendix provides a computer program written in the C++ language compiled using Microsoft's Visual Studio for use with the Windows operating system.

The segment matching process begins at the “start” point seen at 200 in FIG. 2. The digital audio signal samples are first processed in units of about 0.25 seconds each to form distinctive identification key values (sort order values) which are derived from nine Haar wavelet coefficients. As seen at 201 in FIG. 2, the Haar wavelet transform is applied to nine sets of sample amplitude values to obtain weighted averages called “wavelet coefficients.” The time duration of the first five (or six) sets of samples varies from 0.003 to 0.1 seconds, while the remaining four (or three) sets of samples differ in the position where the each set of samples start. The number of sample sets of different durations vs. the number taken at different positions (called the “pivot position”) is randomly varied.

After these nine wavelet coefficients have been calculated at 201, they are sorted as indicated at 203. If the audio waveform contains “simple” content over the interval being processed, the sort order will be the same as the order in which the wavelet coefficients were generated, whereas complex content will generate mixed coefficient values which will be sorted into a substantially different order. For nine coefficients, there are 9!=363,880 possible sort orders. Since simple content tends not to be distinctive, only those sort orders indicating more complex and likely unique waveshapes are retained for further processing as shown at 205. For complex waveforms, the high rate at which complex sort order values is generated creates more values than are needed and more than can be processed without placing excessive burden on the processor. Hence, to reduce the number of values to be processed, eight out of every ten of the “complex” sort order values identified at 205 is randomly discarded as indicated at 207, the decision of which is preferably based on the sort order or other wavelet coefficient relationships in the audio stream input to an irrational Boolean function. Preferably the irrational Boolean function selects the sort orders to discard in a manner that could not be reproduced by any algebraic polynomial to eliminate the possibility that the selection is biased or correlated with any given frequency in the audio stream. Then the selection of “complex” sort orders to discard will be the same selection every time the given audio sequence (song) is captured during later broadcasts, yet unbiased so that all combinations of frequencies will eventually have the opportunity to be involved in the construction of fingerprints. These remaining 9-coefficient sort order values are employed as noted below as index keys for the storage of 32 bit “fingerprint” signals which more fully characterize the audio signal.

Each time the processing at 201 through 207 generates a 9-coefficient sort order value indicating the audio signal being processed is adequately complex, the audio signal is again processed as indicated at 211 using the Haar wavelet transform to yield 32 wavelet coefficients representing the same sample size at consecutive locations in time. These 32 wavelet coefficients are then processed as indicated at 215 in FIG. 2 to identify those of the 16 coefficients having the highest values, and a 32 bit binary word is formed in which each bit position is set to a one if the corresponding wavelet coefficient is one of the 16 high values. Thus, the resulting 32 bit word (referred to here as a “fingerprint” value) has 16 bits set to “1” and 16 bits set to “0”. Because each bit position characterizes the audio signal over a different one of the 32 consecutive sampling periods, the fingerprint value characterizes the shape of the audio waveform.

As they are generated at 215, the 32 bit fingerprint values are stored in an associative memory mechanism implemented as a factorial hash table (FASH). Hash tables are well known data access structures that store information in (key, value) pairs and are generally described, for example, in The Practice of Programming by Brian W. Kernighan and Rob Pike Addison-Wesley Pub Co; 1st edition (Feb. 4, 1999) ISBN: 020161586X and in Algorithms in C, Parts 1-5 by Robert Sedgewick; Addison-Wesley Pub Co; 3rd edition (August, 2001) ISBN: 0201756080. In the present arrangement, the 9-coefficient sort order value is used to construct the key (hash table index) value for storing the 32 bit fingerprint values. Each time a new 32 bit fingerprint value is generated, it is stored in the FASH table at the index location provided by the index that is constructed from the associated 9 coefficient sort order value as indicated at 221.

For each new 32 bit fingerprint, a search is performed as indicated at 311 in FIG. 3 for other, previously stored 32 bit fingerprints that substantially match each newly generated 32 bit fingerprint. Two fingerprint values are deemed to be substantial matches when 12 or more of the 16 flag bits are the same (i.e. the are 12 “1” value bits at the same bit positions in the two 32 bit words being compared). It should be noted that this mechanism effectively searches for signal patterns having the same waveform shape rather than size. As shown at 315, if a matching fingerprint is found that was previously generated within the last 30 seconds, the previously stored matching fingerprint is deleted. In this way, matching fingerprints which are separated by less than 30 seconds are not stored. This mechanism suppresses the storage of fingerprints generated by continuous or more rapidly repeating sounds.

To reduce the computational burden placed on the processor, the “significance” of the fingerprints is determined based on their complexity or uniqueness. The sort order “fingerprint” is associated with a value that is used as its index in the factorial hash (FASH) table seen at 127 in FIG. 1. The sample position (storage location on the audio program storage unit 103) and a unique ID are also assigned in the hash table at the index position. If the fingerprint's index location is already filled, the system looks for a match. In order to do this, it looks at immediately previous fingerprints (allowing some skipping) and compares them to previous fingerprints created when the original hash table entry was created. In other words, the system compares a series of fingerprints to another series of fingerprints already recorded. If the correlation over time matches that of the previous capture, then the system has found a match. Then, it tracks all contiguous fingerprints that can be distance correlated to find the beginning and ending of the song.

Over time, the system will recognize, capture, and log every repeating song and commercial in the audio program store 103. In the audio playback system, recognized segments can be separated into “songs” and “commercials” by considering any repeating segment that is longer than about 130 seconds as a songs, and those that are shorter as commercials.

Conclusion

It is to be understood that the methods and apparatus which have been described above are merely illustrative applications of the principles of the invention. Numerous modifications may be made by those skilled in the area without departing from the true spirit and scope of the invention. For example, although the invention may be employed to particular advantage in a broadcast radio receiver, it should be understood that the principles of the invention may be used to facilitate the identification and playback of audio or video content, or both, obtained from a variety of sources including not only radio and television broadcasts, but also reception via cable or satellite, or provided on media volumes such as compact disk recordings.

1. A method for identifying segments of a broadcast program signal comprising, in combination, the steps of:
receiving said broadcast program signal from an external source,
recording said broadcast program signal as received in a storage device, and
identifying repeating segments of said broadcast program signal.

2. A method for identifying segments of a broadcast program signal as set forth in claim 1 wherein said step of identifying repeating segments of said broadcast program signal comprises the step of comparing a portion of said broadcast program signal with previously received and recorded portions of said broadcast program signal.

3. A method for identifying segments of a broadcast program signal as set forth in claim 1 wherein said method further comprises the step of storing bookmarking information which identifies the location of at least one of said repeating segments in said storage device.

4. A method for identifying segments of a broadcast program signal as set forth in claim 1 further comprising the step of classifying said repeating segments based on their duration.

5. A method for identifying segments of a broadcast program signal as set forth in claim 4 wherein said step of classifying said segments based on their duration consists of determining whether said duration is greater than or less than a predetermined elapsed time duration.

6. A method for identifying segments of a broadcast program signal as set forth in claim 5 wherein repeating segments having a duration greater than said predetermined elapsed time duration are classified as music recordings.

7. A method for identifying recordings in broadcast radio programming containing other content comprising, in combination, the steps of:
recording said broadcast radio programming on a signal storage device,
searching said broadcast radio programming for matching program segments that substantially duplicate one another, and
storing information specifying the location of at least one of said matching program segments.

8. A method for identifying recordings in broadcast radio programming containing other content as set forth in claim 7 wherein said information specifying the location of at least one of said matching program segments contains data indicating the duration of said matching program segments.

9. A method for identifying recordings in broadcast radio programming containing other content as set forth in claim 7 wherein said step of searching said broadcast programming for matching program segments that substantially duplicate one another comprises the substeps of:
extracting a series of fingerprint data values from said broadcast programming, each of said fingerprint data values being indicative of predetermined characteristics of particular segment of said broadcast programming,
storing said fingerprint values in an addressable memory device, and
searching for matching sequences of fingerprint values.

10. A method for identifying recordings in broadcast radio programming containing other content as set forth in claim 9 wherein said substep of searching for matching sequences of fingerprint values comprises creating a sorted index to sequences of said fingerprint values and employing said sorted index to locate matching sequences of index values.

11. A method for identifying recordings in broadcast radio programming containing other content as set forth in claim 9.

12. A method for identifying repeating content in a broadcast program signal comprising, in combination, the steps of:
processing said signal to create a sequence of identification values indicative of the content of a corresponding sequence of intervals of said program signal, and
searching said sequence of identification values for substantially matching patterns of values indicative of said repeating content.

13. A method for identifying repeating content in a broadcast program signal as set forth in claim 12 wherein said step of processing said signal to create a sequence of identification values employs a wavelet transformation.

14. A method for identifying repeating content in a broadcast program signal as set forth in claim 12 wherein said step of processing said signal to create a sequence of identification values comprises the substeps of:
processing different portions of said signal using a wavelet transform to generate a plurality of different wavelet coefficients, and
combining predetermined groups of said wavelet coefficients to create said sequence of identification values.

15. The method for identifying the presence of a pre-recorded program segment in a source program signal comprising, in combination, the steps of:
employing a wavelet transform to extract first sequence of wavelet coefficient values from said pre-recorded program signal,
employing said wavelet transform to extract a second sequence of wavelet coefficient values from said source program signal, and
searching said second sequence for the values substantially matching at least a portion of said first sequence of wavelet coefficient values.

16. The method for identifying the presence of a pre-recorded program segment in a source program signal as set forth in claim 15 wherein said step of searching said second sequence for the values substantially matching at least a portion of said first sequence of wavelet coefficient values comprises the substeps of:
converting said first sequence of wavelet coefficients into at least two identification fingerprint values characterizing the beginning and ending of said pre-recorded program segment,
converting said second sequence of wavelet coefficient values into a succession of fingerprint values charactering successive samples of said source program signal, and
searching said succession of fingerprint values for said identification fingerprint values.

17. The method for identifying the presence of a pre-recorded program segment in a source program signal as set forth in claim 16 wherein each of said fingerprint values comprises a binary word in which selected bits represent corresponding ones of said wavelet coefficients.

18. The method for identifying the presence of a pre-recorded program segment in a source program signal as set forth in claim 16 wherein said first sequence of wavelet coefficient values is extracted from a different portion of said pre-recorded program signal.
